(19) United States
(12) Patent Application Publication
(10) Pub. No.: US 2009/0015793 A1
(43) Pub. Date: Jan. 15, 2009

(54) Integrated Interactive Drawing and Entertainment Projector

(76) Inventors: Kent Suzuki, Oakland, CA (US); Bill Goodman, Cumberland Foreside, ME (US)

Correspondence Address: SWANSON & BRATSCHUN, L.L.C., 8210 SOUTHPARK TERRACE, LITTLETON, CO, 80120, US

(21) Appl. No.: 12/171,470

(22) Filed: Jul. 11, 2008

Related U.S. Application Data
(60) Provisional application No. 60/949,578, filed on Jul. 13, 2007.

(51) Int. Cl. G03B 21/10; G06F 17/00

(52) U.S. Cl. 353/19; 353/44; 235/375

(57) ABSTRACT

An integrated interactive drawing and entertainment projector comprises a base having a top surface defining a receptacle for a sheet of paper. The housing is attached to the base. A film having at least one image thereon is received in the housing. A projector within the housing is operatively associated with the film to project the at least one image on to the top surface of the base defining the receptacle.

### RELATED APPLICATIONS

This application claims priority from U.S. Provisional Patent Application Ser. No. 60/949,578, filed Jul. 13, 2007, entitled “Integrated Interactive Drawing Projector,” which is hereby incorporated by reference.

### TECHNICAL FIELD

Education and entertainment devices, and more particularly an integrated interactive drawing and entertainment projector.

### BACKGROUND

The majority of educational and entertainment toys and devices for kids tend to be passive in nature, for example, television programs and videos played on televisions. Another class of entertainment devices, video games, provide for user interaction but the interaction is limited to pushing select buttons and controls and does little to enhance user small motor skills or to develop creative skills such as drawing and problem solving. While educational computer programs can teach problem solving skills, they fail to effectively teach skills such as drawing and penmanship. The integrated interactive drawing and entertainment projector described in its various embodiments herein is intended to overcome one or more of these problems associated with contemporary educational and entertainment devices.

### SUMMARY

Disclosed and claimed in a number of embodiments is an integrated interactive drawing and educational projector toy that projects images onto a child's paper while corresponding audio provides the child with drawing guidance, music and audio feedback to help the child learn to draw, play games, do puzzles and have fun. The integrated interactive drawing and educational projector requires minimal setup time and minimal parental guidance. Content is structured to guide children through the creation process, thus educating and entertaining the children with essentially no parent guidance. The integrated interactive drawing and entertainment projector in an operative configuration is compact and easily controlled by a child and can be folded to a transport and storage configuration, minimizing its size and protecting sensitive components.

A first aspect is an integrated interactive drawing and entertainment projector comprises a base having a top surface defining a receptacle for a sheet of paper. A housing is attached to the base. A film having at least one image thereon is received in the housing. A projector within the housing is operatively associated with the film to project the at least one image onto the top surface of the base defining the receptacle. In one embodiment a mirror is attached to the housing and the mirror is configured to receive the at least one image projected by the projector and to reflect the at least one image onto the top surface of the base defining the receptacle. The base and the mirror may be pivotally attached to the housing with the mirror and the base each having an operative configuration whereby an image projected by the projector is reflected onto the top surface of the base defining the receptacle and an inoperative configuration wherein the mirror and the base are pivoted into juxtaposition with the housing. In one or more embodiments the film may be part of a cartridge received in the housing and the cartridge comprises a memory integrated circuit storing audio content corresponding to the at least the one image. Further provided in the housing is a player for reading the audio content stored on the memory and playing back the audio content. A plurality of images may be provided on the film and the memory may include audio content corresponding to at least some of the plurality of images. In one or more embodiments a user input or control may be provided on the housing along with an advancement mechanism in the housing for advancing the film and any associated audio to a predetermined image and associated audio content based upon actuation of the user input. Multiple user inputs may be provided on the housing and the housing may further contain means for advancing the film and any associated audio to one of multiple predetermined images and corresponding audio content based upon which user input is actuated by a user. The means for advancing the film and audio may comprise a navigation table stored on the cartridge memory.

Another aspect of the invention is a method of educating and entertaining comprising providing a series of draw images and audio content corresponding to at least some of the draw images. Each draw image is front projected onto a work surface configured to receive a sheet of paper. Any audio content corresponding to a projected image is played back and instructs a user to draw on a sheet of paper received on the work surface based on the projected draw image. The user is presented with at least one input option. Based upon a user response to the at least one input option, another draw image is projected onto the work surface configured to receive a sheet of paper and any corresponding audio content is played back. Multiple user input options may be provided and a navigation table may be provided to project a select image in response to an actuated input option and any corresponding audio content is likewise played back.

Another aspect is a cartridge for storing content. The cartridge comprises a film having first end and a second end. A first reel is configured to spin about a first axis, the first end of the film being attached to the reel so that as the reel spins in a first wind direction about the first axis the film is wound onto the first reel and as the first reel spins in a first unwind direction the film is unwound from the first reel. A second reel is configured to spin about a second axis, the second end of the film being attached to the second reel so that as the second reel spins in a second wind direction about the second axis the film is wound onto the second reel and as the second reel spins in a second unwind direction the film is unwound from the second reel. A drive wheel is configured to spin about a drive axis and the drive wheel is operatively associated with the film to selectively unwind the film from either of the first and second reels, thereby spinning the respective first and second wheels in the first or second unwind direction. Biasing means are operatively associated with the first reel and the second reel to bias each to spin in its respective first or second wind direction as the other is spun in its unwind direction. In one embodiment the first wind direction and the second wind direction are the same and the first unwind and second unwind directions are the same. In one embodiment the biasing means comprises an elastic band having a first end and a second end. A first band reel is configured to rotate with the first reel about the first axis and the first end of the elastic band is attached to the first band reel. A second band reel is configured to rotate with the second reel about the second axis and the second end of the elastic band is attached to the second band reel. The elastic band is configured to extend between the first band reel and the second band reel to provide an elastic force therebetween and to wind onto one band reel and unwind from the other band reel as the first and second reels spin in their first and second unwind directions. In one embodiment the drive wheel is a sprocket having a plurality of teeth on its circumference and the film has lengthwise spaced perforations mating with the spaced teeth. The cartridge may further comprise a plurality of idlers operatively associated with the film to guide the film between the first and second reels.

A further aspect of the present invention is an image location system for a film cartridge, the film comprising a plurality of image frames spaced lengthwise of the film. The image location system comprises an optical marker operatively associated with each image frame. An optical scanner is operatively associated with the film for scanning the optical markers. A counter is operatively associated with the optical scanner for counting optical markers detected by the optical scanner. In one or more embodiments the film has a first end attached to one reel and a second end attached to another reel and a near-end optical marker is operatively associated with a frame near each of first and second ends, the near end optical markers indicating close proximity to the corresponding end of the film. One or more embodiments may include an optical marker operatively associated with a first frame of the film indicating the first frame and an optical marker operatively associated with a last frame of the film indicating the last frame. Embodiments of the image location system may further comprise a film drive operatively associated with the film for driving the film. The drive is operative at a first speed for movement between frames of greater than a select distance apart and operative at a second speed for movement between frames of less than a select distance apart, the first speed being greater than the second speed. Further embodiments may comprise a processor operatively associated with the film drive and the optical scanner, the processor comprising the counter and the processor accessing a navigation table associated with the film, the processor being linked to a plurality of user inputs, the processor actuating the film drive between select film images in accordance with the navigation table in response to actuation of a user input.

The various aspects and embodiments described herein provide for an integrated drawing and entertainment projector for guiding a user to draw various images in an orderly and logical sequence to teach the user to draw. Further entertainment such as mazes including audio clues may be displayed by the integrated drawing and entertainment projector. Further content could include crafts of all sorts, puzzles, Sudoku, crosswords, word finders, word jumbles and the like. Further educational aspects could include phonics, spelling and penmanship. Other content such as a greeting card maker could be provided.

### BRIEF DESCRIPTION OF THE DRAWINGS

FIG. 1 is a perspective view of one embodiment of an integrated drawing and entertainment projector;

FIG. 2 is a side perspective view of the integrated drawing and entertainment projector of FIG. 1 in a transport position;

FIG. 3 is a rear perspective view of the integrated drawing and entertainment projector of FIG. 1 in a transport position;

FIG. 4 is a front elevation view of another embodiment of an integrated drawing and entertainment projector;

FIG. 5 is a functional block diagram of an integrated drawing and entertainment projector;

FIG. 6 is a perspective view of a first embodiment of a cartridge mechanism for use with an integrated drawing and entertainment projector;

FIG. 7 is a perspective view indicating dual reels of the cartridge mechanism of FIG. 6;

FIG. 8 is a plan view illustrating a film and rewind path of the cartridge of FIG. 6;

FIG. 9 is a segment of film for use in the cartridge of FIG. 6 or FIG. 11;

FIG. 10 is a firmware flowchart for the integrated drawing and entertainment projector; and

FIG. 11 is a perspective view of a second embodiment of a cartridge mechanism with the top removed.

### DETAILED DESCRIPTION

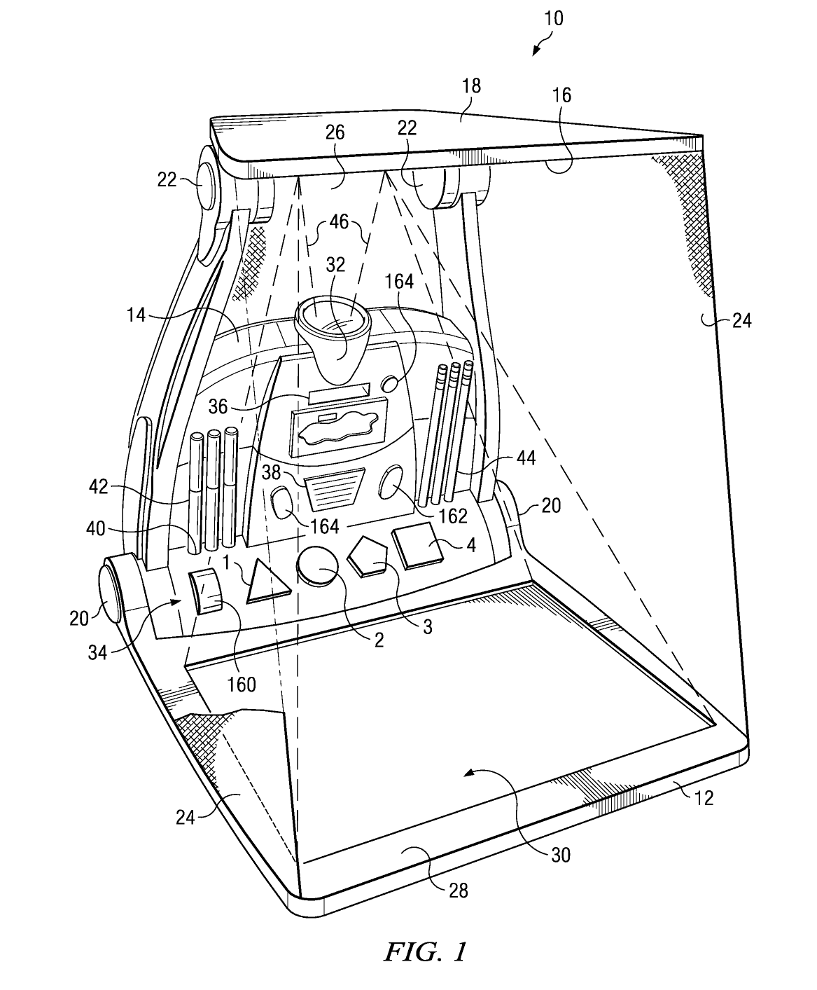

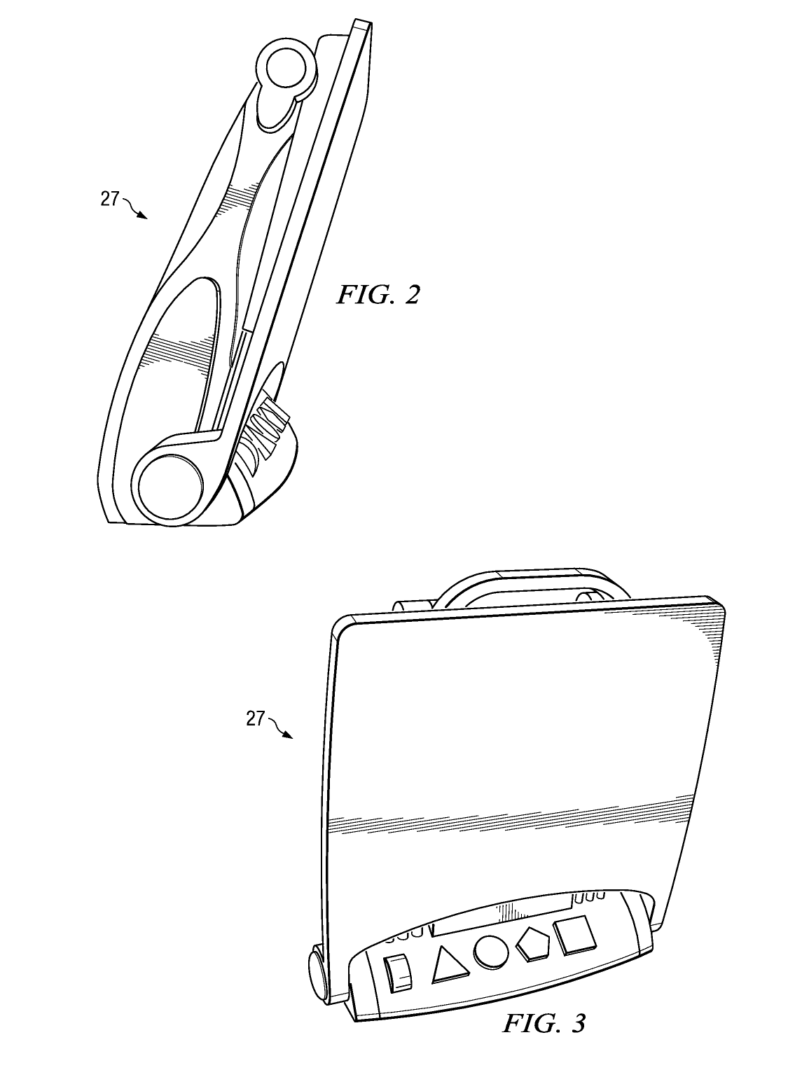

FIG. 1 is a perspective view of an integrated drawing and entertainment projector 10 in an operative configuration. The integrated drawing and entertainment projector 10 includes a base 12, a housing 14 and a mirror 16 attached to the underside of a top shroud 18. The base 12 is pivotally connected to the housing 14 by hinges 20. In a similar manner, the mirror 16 is pivotally connected to the housing 14 by hinges 22 coupled to the top shroud 18. Also included in FIG. 1 are side shrouds 24 and a rear shroud 26. The side and rear shrouds 24, 26 may be made of a flexible sheet material and may further include a mechanism to collapse the shrouds inward as the mirror 16 and base 12 are pivoted about the base 12 into juxtaposition with the base 12 in a storage and transport configuration 27 illustrated in FIGS. 2 and 3.

The base 12 has a top surface 28 defining a receptacle 30 which is configured to receive a sheet of paper therein. The sides of the receptacle 30 operate to stabilize a paper received in the receptacle during use by a user. The receptacle 30 may be configured to receive a standard sized sheet of paper, such as a 8 ½×11 sheet of paper.

The housing 14 supports a projector 32, a number of user inputs or controls 34, a cartridge opening 36 and a speaker grill 38. The housing may also include a number of slots 40 for holding pens 42 or pencils 44 as illustrated in FIG. 1. The projector 32, mirror 16 and receptacle 30 on the top surface of the base 12 are configured so that in use an image depicted by the ghost lines 46 projected by the projector 32 is directed upon the top surface of the receptacle 30. As illustrated in FIG. 1, this is accomplished by the projector projecting the image directly on the mirror 16 which reflects the image onto the top surface of the receptacle 30.

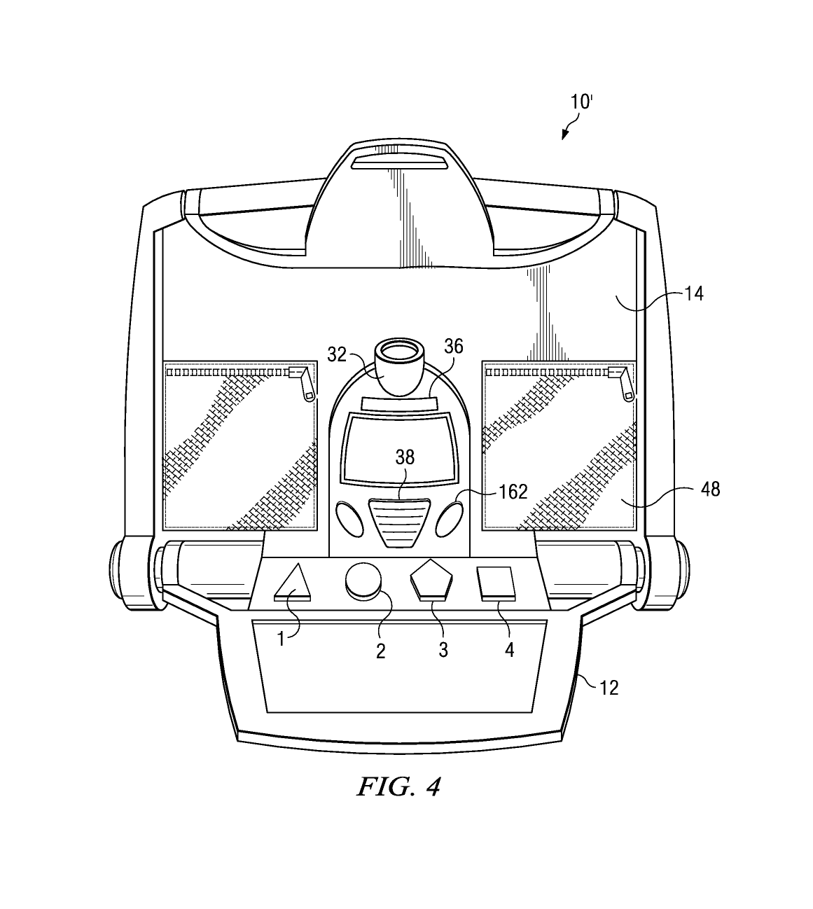

FIG. 4 is a front view of an alternate embodiment 10′ of the integrated drawing and entertainment projector 10 of FIG. 1. The principal difference between the embodiment 10 of FIGS. 1-3 and the alternate embodiment 10′ depicted in FIG. 4 is that zippered mesh pouches 48 replace the holes 40.

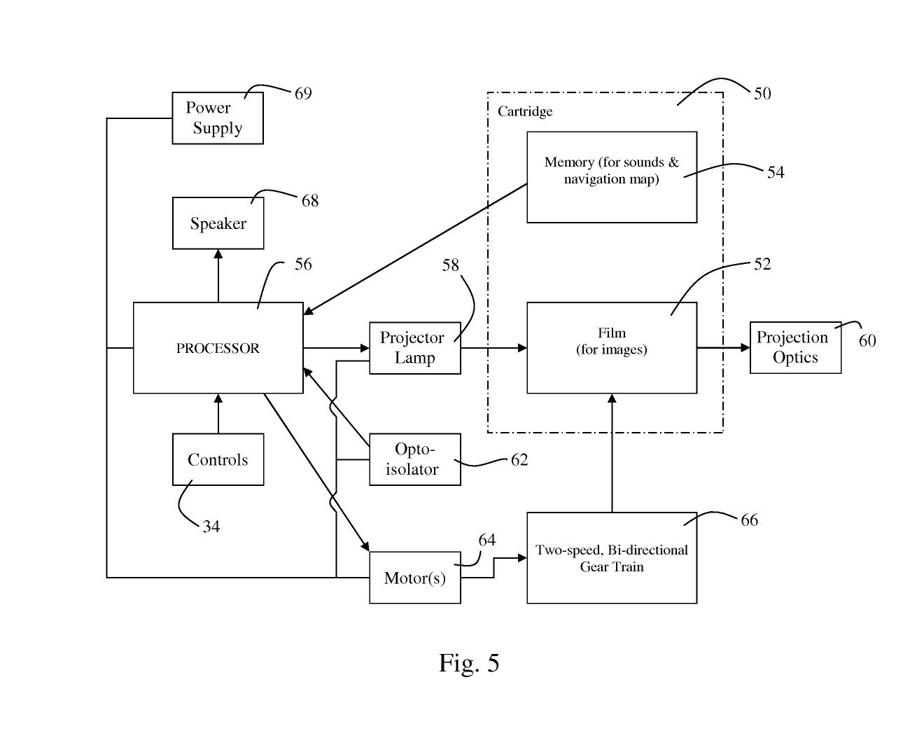

Contained within the housing 14 are a number of components for controlling, projecting and playing content on a cartridge received in the cartridge slot 36. These components are illustrated schematically in the functional block diagram of FIG. 5.

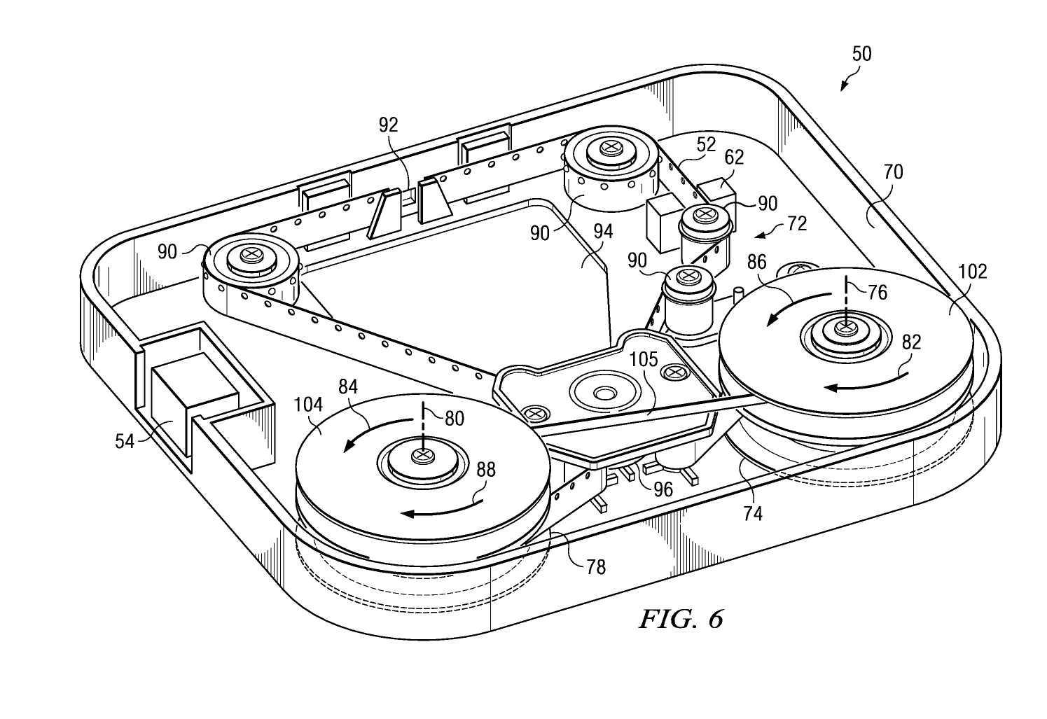

A cartridge 50 received in the cartridge slot 36 will be described in greater detail with reference to FIGS. 6-9. For the present it is necessary to note that the cartridge 50 includes a film 52 and a memory 54. The film 52 may be, by way of example, a Super 8 mm film. The memory 54 may be a masked Read Only Memory (ROM) and is intended to carry audio content corresponding to images carried by the film 52 and a navigation table used by a processor 56 for controlling image display and audio playback as will be described in greater detail below. By way of example, the memory may be a masked-ROM chip.

The processor 56 may be implemented with any computer or game processor which has the capacity to provide the functionality described herein. For example, the processor 56 may be a GPCE 16-bit processor such as a Generalplus GPCE 040A, which has the advantage of using a low-bit-rate CELP-like speech compression algorithm in order to maximize the minutes of speech from the memory 54. The processor 56 is configured to receive audio data and the navigation map from the memory 54. The processor 56 is also coupled to a projector lamp 58 for turning the projector lamp 58 on and off as necessary for projecting images from the film 52 through the projection optics 60 as illustrated by the ghost lines 46 in FIG. 1. The processor 56 is also coupled to an optoisolator 62 for receiving signals therefrom. The optoisolator is in turn operatively associated with the film for detecting and reading optical markings (for example, bar codes) on the film as will be described in greater detail below. The processor 56 is further coupled to a motor 64 which cooperates with a two speed bidirectional gear train 66 to function in part as a drive operatively associated with the film 52 for controlling film movement in response to user inputs and in accordance with the navigation map. Also coupled to the processor 56 is a speaker 68 for playing back audio signals from the memory 54. The speaker 68 is located adjacent to the speaker grill 38 to play back the sound to a user. All components requiring power described herein are powered by a power supply 69 which may be an onboard power source such as batteries in communication with a power management circuit or a connection to an AC adapter as is customary for consumer electronic devices. Finally, a number of controls 34 on the housing are coupled to the processor 56.

A first embodiment of a cartridge 50 is illustrated in FIG. 6. The cartridge 50 consists of a housing 70 containing a film feed mechanism 72, the film 52 and the memory 54. The cartridge 50 is depicted in FIG. 6 with the top of the housing 70 removed for clarity.

The film feed mechanism 72 comprises a first film reel 74 configured to rotate about a first axis 76 and second film reel 78 configured to rotate about a second axis 80. A first end of the film 52 is attached to the first film reel 74 and a second end of the film 52 is attached to the second film reel 78. As the first film reel 74 rotates about the first axis 76 in a wind direction 82, which is clockwise as illustrated in FIG. 6, film is wound onto the first film reel 74 and the second film reel 78 rotates in a second unwind direction 84, which is counterclockwise as depicted in FIG. 6, to provide the film. The first film reel 74 is rotated in an unwind direction 86 about the axis 76 to unwind the film from the first film reel 74. The film is correspondingly wound onto the second film reel 76 as the second film reel is rotated in a second wind direction 88 about the axis 80. As depicted in FIG. 6, the first unwind direction 86 is counterclockwise and the second wind direction 88 is clockwise.

With further reference to FIG. 6, film is directed between the first and second film reels by a plurality of idlers 90 along a film path that brings individual film frames into alignment with an opening 92 in the cartridge housing 70. The cartridge housing 70 is configured so that the projector lamp 58 mates with the cavity 94 with the cartridge in the cartridge slot 36 so that images on the film are projected from the opening 92 through projection optics 60 depicted in FIG. 5. The film path also brings the film into communication with the optoisolator 62 for tracking film position.

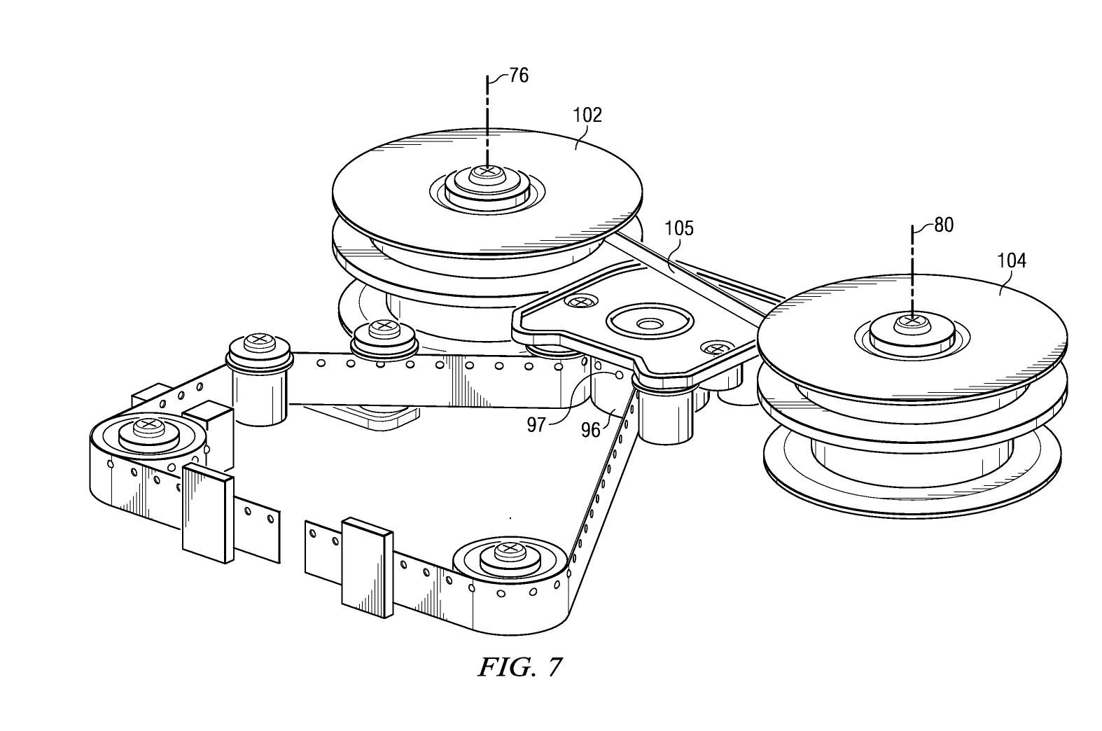

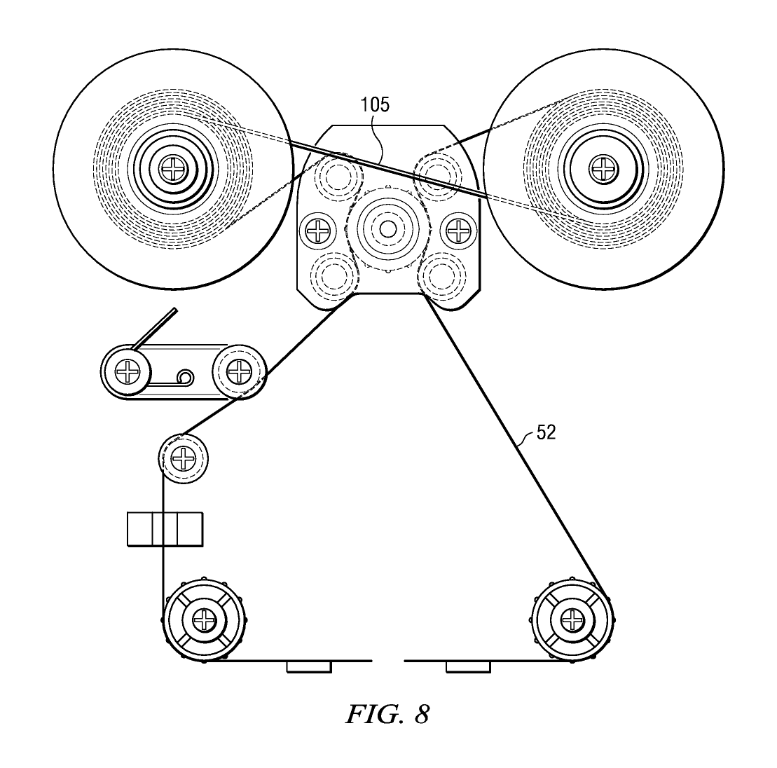

The film is driven between the respective reels by a sprocket 96 having a number of teeth 97 about its circumference (see FIG. 7) configured to engage with lengthwise perforations in the film 52. The sprocket 96 in turn mates with a drive shaft linked to the gear train 66 (see FIG. 5) with the cartridge 50 in the cartridge slot 36. As depicted in FIGS. 6 and 8, as the sprocket rotates in a counterclockwise direction, first film reel 74 is rotated in the first unwind direction 86 and as the sprocket is rotated in the clockwise direction the second film reel 78 is rotated in the second unwind direction 84. In order to provide for take up of the film on the opposite reel, a biasing means is provided to spin the respective first or second wheels in their respective first or second wind direction as the other reel is spun in its unwind direction.

Referring to FIGS. 6 and 7, the biasing means of the cartridge 50 comprises a first band reel 102 operatively associated with the first reel 74 to rotate with the first reel 74 about the first axis 76 and a second band reel 104 configured to rotate with second film reel 78 about the second axis 80. An elastic band 105 having a first end attached to the first band reel 102 and a second end attached to the second band reel 104 extends between the first and second band reels and is configured to bias each of the first and second band reels to rotate the first and second reels 74, 78 in their respective wind directions as the other is spun in an unwind direction. This is accomplished in the embodiment illustrated in FIG. 6 by the elastic band 105 being wound about the first and second band reels in opposite directions. In this manner, as the sprocket 96 rotates in a counterclockwise direction, thus driving the first reel in the counterclockwise first unwind direction 86, the elastic band 105 is wound onto the first band reel 102 and the elastic band 105 causes rotation of the second reel in the second wind direction 88 to wind the film onto the reel 78. In a like manner, when the sprocket 96 rotates in a clockwise direction causing the second reel to rotate in the second unwind direction 84, the elastic band 105 is wound onto the second band reel 104 and the elastic band 105 causes rotation of the first band reel 102 and correspondingly the first reel 74 in the first wind direction 82. Thus, as film is wound onto either of the first and second reels, the elastic band 105 is unwound from the corresponding first or second band reel and vice versa. Use of the elastic band in this manner is highly desirable because it provides essentially the same winding bias force regardless of which reel has more of the film wound on it. This enables the single sprocket to function to drive the film in either of a clockwise or counterclockwise direction with the elastic band providing for take up of the film with a relatively constant take up on the winding reel. Various alternate embodiments can provide for the film being wound and unwound from the first and second reels in other directions than the embodiment described herein and likewise the elastic band could be wound and unwound from the first and second band reels in other directions depending on various factors such as the location of the sprocket 96 and other design considerations.

The sprocket 96 also has detents on its underside corresponding to each of its teeth. These detents allow the film to be registered exactly, and keep the film from moving once the sprocket has moved it to the proper frame.

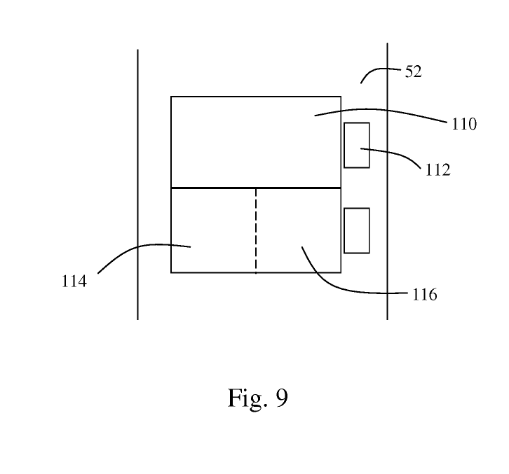

FIG. 9 is a schematic plan view of a segment of the film 52. The film 52 consists of a number of frames 110 along its length with a perforation 112 aligned with the center of each frame 110. In one embodiment, each frame 110 is divided into an image frame 114 and an optical marking 116. The optical marking 116 may be, by way of example, a bar code. The optical marking 116 registers with and is read by the optoisolator 62 to provide feedback to the processor 56 of the image frame location. The optical marking may, for example, associate each image frame 114 with a sequential number such that a first image frame is marked as number 1 and a second is marked as number 2 and so on, through a last image frame. Alternatively, the optical marker may simply cooperate with a counter in the processor which determines frame position by counting from a first frame. Other embodiments could include numbering every ten frames with a counter locating frames between enumerated frames. In any event, the drive mechanism, optical markings and optoisolator cooperate to provide precise positioning of a select image frame 114 in alignment with the opening 92 to allow for projection of a select image.

The optical markings 116 may further include a “near end” marking near each of the first and second ends of the film 52. The purpose of the near end markings is to alert the processor that an end of the film is approaching so that the motor can be slowed to prevent damage to the film or drive mechanism by attempting to wind beyond a first or last end of the film.

The two speed, bi-directional gear train allows the sprocket 96 to be rotated in either a clockwise or counterclockwise direction at a first and second speed, with the first speed being greater than the second speed. The processor is programmed to rotate the sprocket at the first speed when it is to advance the film more than a select number of frames, for example 5 frames, and at the second speed when advancing the film less than the select number of frames, for example 4 frames. In addition, the processor is programmed to transition from the first speed to the second speed as the desired frame approaches alignment with the opening 92 to prevent undue stress on the film and to aid in precise alignment with the opening. By way of example, slow speed may advance the film at a rate of 250 milliseconds per frame. The fast speed may advance the film at a rate of 25 milliseconds per frame.

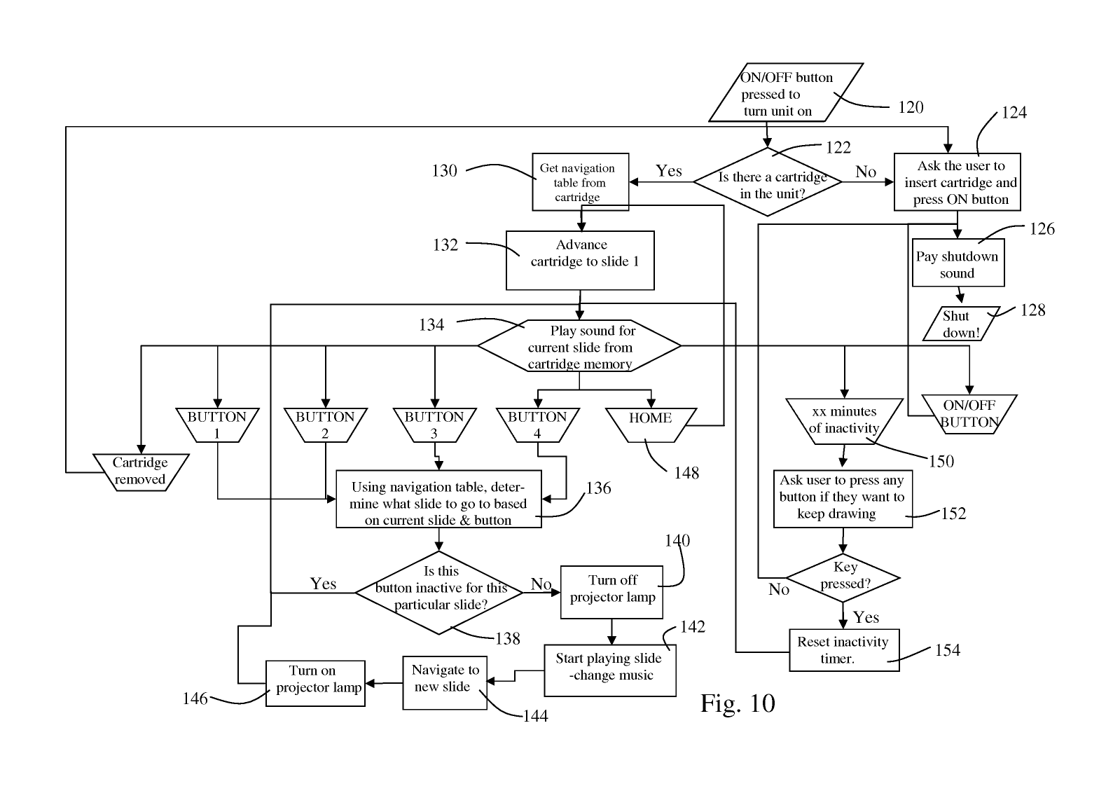

FIG. 10 is a flowchart of firmware associated with the processor 56. When a control button is actuated to turn the unit on 120, a determination is made at 122 whether a cartridge is in the unit. If no cartridge is in the unit, at 124 the user is prompted to insert a cartridge in the unit and press an “on” button. If the user does not respond by inserting a cartridge and pressing the on button, shut down music is played at 126 and the unit is shut down at 128. If there is a cartridge in the unit at 122 or if a cartridge is inserted and the on button pressed in accordance with the instructions at 124, the processor retrieves the navigation table from the cartridge at 130. The cartridge is advanced to slide 1 at 132. Sound for the current slide is played from the cartridge memory at 134 and the user is provided instructions. For example, the user may be instructed to draw an image that has been projected onto a sheet of paper received into the receptacle 30. Instructions may then present options to the user and prompt a response by pushing one of the control buttons. Depending which control button is pushed, at 136 the processor users the navigation table to determine which slide to go to based on the current slide and button pressed. At 138 the processor assures the button selected is not inactive and assuming the button is not inactive, the projector lamp is turned off at 140, slide change music is played at 142, the processor actuates the drive mechanism to a select slide at 144 and the lamp is turned on at 146. Steps 134-146 may be repeated until the completion of a drawing exercise or activity. At any time actuation of the home indicated at 148 will return the slide to slide number 1. If there is no activity on the unit for a select period of time, as determined at 150, at 152 the user is prompted to push a button if they want to continue. If no key is pushed the unit shuts down and if a key is pushed the activity timer is reset at 154.

The various controls referenced above are shown on the housing 14 in FIG. 1. Buttons 1-4 are illustrated in distinctive shapes including a triangle, circle, pentagon and square for ease of instruction to young children. A volume knob 160 allows for control of the volume and could also function as an on/off switch. A home button 162 is provided on the housing for returning to a first frame as described above and a help button will prompt the processor to provide assistance to the user. An eject button 164 ejects the cartridge 50 from the cartridge slot 36 and disengages the sprocket from the gear train 66.

The navigation table provides an entry for each slide on the film and the entry prompts the processor to play a corresponding audio clip, if any, and provides direction to the processor for advancing to another slide in response to actuation of one of buttons 1-4 or the home button 162. By way of example, an entry in the navigation table may effectively be read as follows:

When you're at slide #100:
Play audio clip #25
If button 1 is pressed, go to slide #27
If button 2 is pressed, go to slide #99
If button 3 is pressed, go to slide #56
If button 4 is pressed, go to slide #78
If HOME button is pressed, go to slide #1
If REPEAT button is pressed, play audio clip #25

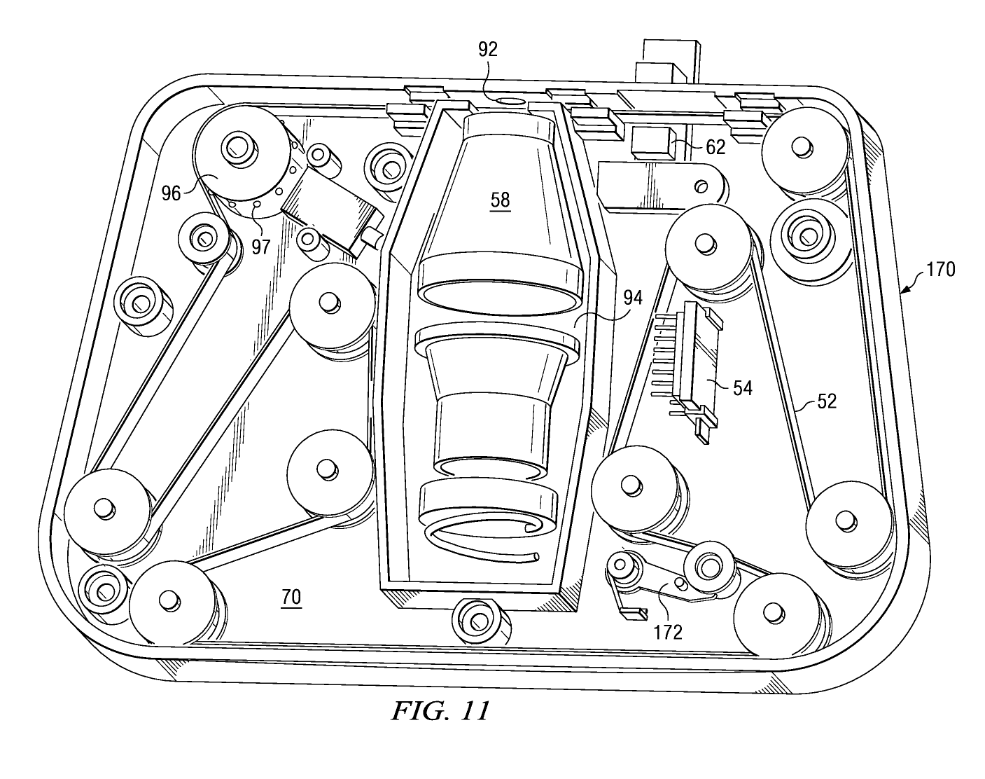

FIG. 11 is an alternate embodiment of a cartridge 170 with its top removed for clarity. The alternate embodiment 170 has like elements marked with the same reference numbers as the first embodiment of the cartridge 50 illustrated in FIGS. 6-8. The primary difference between the embodiments is the second cartridge embodiment 170 does not have the reels 74, 78, but instead has a continuous loop of the film 52. This eliminates the need not only for the reel, but for the biasing means discussed above with reference to FIGS. 6 and 7. One additional element of the second embodiment of the cartridge 170 is a tensioner 172 for maintaining a proper tension on the film 52. One other obvious difference in the second embodiment of the cartridge 170 is the optical markers would not require a “near end” marking near the first and second ends of the film 52 as the film is a continuous loop.

Various embodiments of the disclosure could also include permutations of the various elements recited in the claims as if each dependent claim was multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

What is claimed is:

1. An integrated drawing and entertainment projector comprising:
a base having a top surface defining a receptacle for a sheet of paper;
a housing attached to the base;
a film having at least one image thereon received in the housing; and
a projector within the housing operatively associated with the film to project the at least one image onto the top surface of the base defining the receptacle.

2. The integrated drawing and entertainment projector of claim 1 further comprising a mirror attached to the housing, the mirror being configured to receive the at least one image projected by the projector and reflect the at least one image onto the top surface of the base defining the receptacle.

3. The integrated drawing and entertainment projector of claim 2 further comprising the base and the mirror being pivotably attached to the housing, the mirror and the base each having an operative position whereby an image projected by the projector is reflected onto the top surface of the base defining the receptacle and an inoperative position whereby the mirror and the base are pivoted into juxtaposition with the housing.

4. The integrated drawing and entertainment projector of claim 1 further comprising the film being part of a cartridge received in the housing, the cartridge comprising a memory storing audio content corresponding to at least one image, the apparatus further comprising means in the housing for playing back the audio content.

5. The integrated drawing and entertainment projector of 4 further comprising a plurality of images on the film and audio content corresponding to at least some of the plurality of images.

6. The integrated drawing and entertainment projector of claim 5 further comprising a user input on the housing and means for advancing to the film and audio to a predetermined image and audio content based upon actuation of the user input.

7. The integrated drawing and entertainment projector of claim 6 further comprising multiple user inputs on the housing and means for advancing the film and audio to one of multiple predetermined images and audio content based upon which user input is actuated by a user.

8. The integrated drawing and entertainment projector of claim 7 wherein the means for advancing the film and audio comprises a navigation table stored on the cartridge.

9. A method of educating and entertaining comprising:
providing a series of draw images and audio content corresponding to at least some of the draw images;
front projecting each draw image on to a work surface configured to receive a sheet of paper;
playing back any audio content corresponding to a projected draw image instructing a user to draw on a sheet of paper received on the work surface based on the projected draw image;
presenting the user at least one input option; and
advancing to another draw image and any corresponding audio content based upon the user response to the at least one input option.

10. An image location system for a film cartridge, the film comprising a plurality of image frames spaced lengthwise of the film, the image location system comprising:
an optical marker operatively associated with a each image frame;
an optical scanner operatively associated with the film for scanning the optical markers; and
a counter operatively associated with the optical scanner for counting optical markers detected by the optical scanner.

11. The image location system of claim 10 further comprising a film drive operatively associated with the film for driving the film between the reels, the drive being operative at a first speed for movement between frames of greater than a select distance apart and operative at a second speed for movement between frames of less than a select distance apart, the first speed being greater than the second speed.

12. The image location system of claim 11 further comprising a processor operatively associated with the film drive and the optical scanner, the processor comprising the counter and the processor accessing a navigation table associated with the film, the processor being linked to a plurality of user inputs, the processor actuating the film drive between select film images in accordance with the navigation table in response to actuation of a user input.
